(19) United States
(12) Patent Application Publication
(10) Pub. No.: US 2016/0009311 A1
(43) Pub. Date: Jan. 14, 2016

(54) FRICTION CLUTCH FOR STEERING COLUMN

(71) Applicant: ZF Steering Systems, LLC, Northville, MI (US)

(72) Inventors: Pritish KHALE, Louisville, KY (US); Olivier PERICHON, Independence, KY (US); Ricky Joe MAINS, JR., Morningview, KY (US)

(21) Appl. No.: 14/326,937

(22) Filed: Jul. 9, 2014

(51) Int. Cl. B62D 1/184

(52) U.S. Cl. CPC B62D 1/184

(57) ABSTRACT

The friction clutch includes a first clutching surface and a second clutching surface configured to be pressed against each other. Friction between the surfaces needs to be overcome for one surface to rotate relative to the other. The first clutching surface is configured to be axially and rotationally fixed relative to the steering shaft. The second clutching surface is configured to allow relative rotational movement between such surface and the steering shaft. When unlocked the second clutching surface rotates with the first clutching surface and steering shaft due to friction. When locked, the rotational position of the second clutching surface is fixed so as not to rotate with the first clutching surface and steering shaft. The friction must be overcome for the steering shaft to rotate. The friction can be overcome by application of sufficient external torque at the steering wheel. A controller controls locking and unlocking.

### BACKGROUND OF THE INVENTION

This invention generally relates to automotive steering column devices, and more particularly to a friction clutch for maintaining steering shaft position.

Automated technologies for vehicle operation have led to improved fuel efficiency, improved battery life, cruise control, and other safety features and driving conveniences. Continued advancement is leading toward self-driving vehicles. A self-driving vehicle assumes full control of vehicle movement under favorable traffic and weather conditions. Additional features needed for accomplishment of self-driving vehicles, include for example, adaptive stability control for braking, adaptive cruise control for maintaining a safe distance between vehicles, and lane keeping for adjusting steering.

Conventional automobiles include power steering systems for assisting the driver in changing the vehicle's wheel angles for steering the vehicle. The driver applies a manual torque to a steering wheel, which via a shaft is coupled for example to a rack and pinion. A steering angle input from the steering wheel is applied to the pinion and rack to adjust the wheel angle, and thus the steering. An electric motor generates an additional torque to supplement the manual torque so as to make the vehicle steering easier to control. The manual torque together with the additional torque is applied to the pinion and rack.

In a self driving vehicle an automated steering control mode may used where the driver need not generate a manual torque with the steering wheel to steer the vehicle. The steering shaft instead is turned by an automated steering system. For example, a controller may control the electric motor to apply a torque to the steering shaft. Such torque is based on the automated steering control rather than a control for giving a power assist to a manual torque.

Concerns about self-driving vehicles include passenger and vehicle safety in the event of a failure. This invention addresses the safety issue in the presence of a failure of the automated steering control.

### SUMMARY OF THE INVENTION

A friction clutch of the present invention includes a first clutching surface and a second clutching surface configured to be pressed against each other with a clutching force applied in a manner for resisting rotation of a steering shaft. The first clutching surface is configured to be axially and rotationally fixed relative to the steering shaft. The second clutching surface is configured to be on a component having an axial through opening, so as to allow rotation of the steering shaft within the axial through opening. A locking component has a locked position in which the locking component fixes a rotational position of the second clutching surface.

A controller controls whether the locking component is positioned in or out of the locked position. The first and second clutching surfaces and the locking component are configured so that while the locking component is in the locked position the clutching force resists rotation of the steering shaft. The clutching force can be overridden by application of an external torque at the steering wheel that corresponds to an overriding force acting on the steering shaft exceeding the clutching force.

While the locking component is in the unlocked position the friction force between the first and second clutching surface is present. Since the steering shaft is fixed relative to the first clutching surface but can rotate relative to the second clutching surface, the friction force causes the second clutching surface to rotate with the first rotating surface (which is fixed so as to rotate with the steering shaft).

The friction clutch apparatus may include a collar and a friction wedge configured to be installed along the steering shaft between a first barrier and a second barrier fixed relative to the steering shaft. The collar is configured to allow rotation of the steering shaft within an axial through opening while the friction clutch is active (i.e., in the locked position) within a frictional force operational range. The friction wedge is concentrically inward of the collar. An outer surface of the friction wedge serves as the first clutching surface. The inner surface of the collar serves as the second clutching surface.

The friction clutch apparatus also may include a tuning spring installed along the steering shaft between the friction wedge and one of the first and second barriers. One of the barriers positioned relative to the other to define a compressed length of the tuning spring. Such compressed length determines forces by which the spring acts upon the friction wedge. Such forces determine the frictional force operational range of the friction clutch.

In some embodiments the friction clutch is configured as a failsafe apparatus for clutching the steering shaft to simulate a driver holding a position of a steering wheel during a failure of automated steering control in a vehicle having a self-driving mode and a manual driving mode. The first and second clutching surface and the locking component are configured so that the clutching force simulates a driver holding a steering wheel at a current rotational position of the steering shaft. The clutching force can be overcome by the driver grabbing the wheel, and applying a manual torque to overcome the frictional force between the two clutching surfaces.

The inventions will be better understood by reference to the following detailed description taken in conjunction with the accompanying drawings.

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown.

### BRIEF DESCRIPTION OF THE DRAWINGS

FIG. 1 is a perspective view of an exemplary steering system for which the friction clutch of the present invention may be used;

FIG. 2 is a perspective, partially-exploded view of the friction clutch according to an embodiment of the present invention installed to a steering shaft;

FIG. 3 is an exploded view of several components of the friction clutch of FIG. 2;

FIG. 4 is a perspective view of the friction clutch together with a steering shaft according to an embodiment of the present invention;

FIG. 5 is a perspective view of the friction clutch together with a steering shaft and steering column according to an embodiment of the present invention;

FIG. 6 is a sectional view of the steering clutch and steering shaft of FIG. 2;

FIG. 7 is a diagram of the steering clutch in the locked position;

FIG. 8 is a diagram of the steering clutch in the unlocked position; and

FIG. 9 is a diagram of the teeth at a distal end of the lock bolt of FIG. 3.

### DETAILED DESCRIPTION OF THE PREFERRED EMBODIMENTS

In the following description, for purposes of explanation and not limitation, specific details may be set forth to provide a thorough understanding of the present invention. However, it will be apparent to one skilled in the art that the present invention may be practiced in other embodiments that depart from these specific details. Detailed descriptions of well-known components are omitted so as not to obscure the description of the present invention.

A friction clutch of the present invention is part of a steering system and serves to hold a steering shaft in a current rotational position. In preferred embodiments the friction clutch has an operational range of force. So long as forces applied to the steering shaft are less than a selected value within the operational range, then the steering shaft is held against rotation. When a force is applied that exceeds the selected value, then the steering shaft overcomes the clutch and rotates. The selected value may be set so that the force corresponding to a vehicle driver grabbing the steering wheel in a manner for turning the wheel is sufficient to overcome the friction clutch.

Generally, the torque required by a vehicle driver to turn a vehicle's steering wheel is predetermined by the vehicle manufacturer for the given vehicle model. Typically, such predetermined torque is less than 0.2 Newton-meters (Nm). In one embodiment of the present invention, the operational range is prescribed preferably to be 2 Nm to 15 Nm, although a different range may be implemented. The minimum value may be as low as the predetermined torque (e.g., 0.2 Nm) for the vehicle. The maximum value is set to be within a range of torque that a vehicle driver reasonably can be expected to apply to the steering wheel. A tuning spring is used to set the specific torque value within the operational range, which is needed to overcome the friction clutch. Such specific value is the selected value discussed above, and may be any value within the operational range. The selected value is determined at least in part by compression of the tuning spring.

In an example implementation, the friction clutch is used to hold a steering wheel in position during a vehicle self-driving operation. In a specific implementation, the vehicle driver enters a command (e.g., pushes a button or taps an input area of a touch screen). The vehicle then goes into a self-driving mode. During self-driving mode, a controller locks the friction clutch into position to hold a current steering shaft rotational position. During the self-driving mode, the controller may determine that the steering shaft needs to be turned, so as to redirect or adjust the vehicle direction of travel. The controller unlocks the friction clutch, then commands the steering shaft be turned (e.g., by a command to a motor to turn the shaft). During the operation, the controller will determine that the steering shaft should be held at a then current position. The controller therefore sends a signal to lock the friction clutch. Locking and unlocking of the friction clutch may occur often during self-driving mode as the vehicle is automatically steered to navigate the vehicle by maintaining, adjusting, or changing a vehicle heading.

In another implementation, the friction clutch serves as a failsafe device for the automated steering system. For example, in the event of a loss of vehicle power while in self-driving mode, or a failure of an automated steering control mechanism, the friction clutch locks thereby holding the steering shaft at its current rotational position. Correspondingly, the steering wheel also is held at the then current position. This is particularly useful when the car is in the midst of a turn or rounding a curve during a failure. The driver may observe that a failure has occurred and grab the steering wheel. In particular the driver may apply a force to the steering wheel, exceeding the predefined select force, which is sufficient to overcome the frictional force of the friction clutch and thereby turn the steering shaft to control vehicle steering.

### Host Steering System

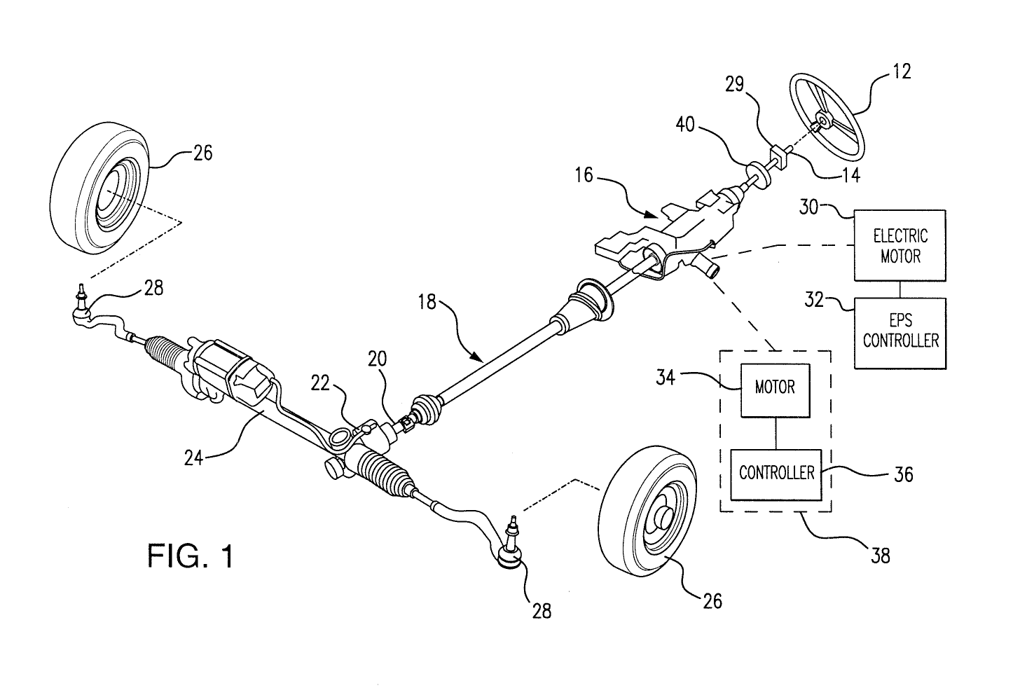

FIG. 1 shows an exemplary steering system for which an embodiment of the friction clutch of the present invention may be used. Although a rack and pinion power steering system is illustrated, other steering systems also may host the friction clutch. Of significance is that the host steering system 10 includes both a manual steering mode and a non-manual, automated steering mode, such as hands-free automatic steering in a self-driving vehicle.

In the illustrated steering system 10, a steering wheel 12 is attached to a steering shaft 14, which runs through a steering column 16. The steering shaft 14 is coupled to an intermediate shaft 18, which in turn is coupled to an input shaft 20 at a pinion 22. The pinion 20 is coupled to a rack 24. Vehicle wheels 26 are coupled to the pinion via a linkage assembly 28. The wheels 26 are steered by a drive torque applied by the input shaft 20 to the pinion 22.

In a manual steering mode, the drive torque is a combination of a manual torque input by the driver at the steering wheel 12 and an additional torque input by an electric motor 30 of a power steering system. The driver generates the manual torque by turning the steering wheel 12. The additional torque may be applied as a power assist to supplement the manual torque so as to generate a desired drive torque at the pinion 22 via the intermediate shaft 18 and input shaft 20. Such additional torque, for example, is applied by an electric motor 30 as controlled by an electronic power steering (EPS) controller 32 which may determine the desired drive torque based on a control algorithm.

In the non-manual automated steering mode, (e.g., hands-free automated driving), a self-steering input torque is generated by a motor 34 controlled by a controller 36. The motor 34 and controller 36 are part of an automated steering system 38. Each controller 32, 36 may be embodied by a same or a separate processing subsystem including a processor and memory. A self-steering control module hosted by the processing subsystem corresponding to controller 36 determines output controls for controlling the motor 34 to generate the self-steering input torque. The motor 34 may be a separate distinct motor from the motor 30 or may be the same motor specimen.

In some embodiments the self-steering controller 36 may also implement and perform the power steering controls to assure a safe desired drive torque is computed and applied to the pinion 22. Accordingly, the power steering controls may be combined with the self-steering controls to generate a single control to a single motor specimen. In such embodiment the torque generated is the drive torque. In other embodiments the power steering controls may be generated distinct from the self-steering controls and supply an additional torque to the self-steering torque. In such embodiment the self-steering torque replaces the manual torque, which then is combined with the power assist torque to generate the drive torque at the pinion 22.

In some embodiments the steering system 10 may include or have installed a steering lock mechanism 29. The steering lock mechanism 29 is an anti-theft device that prevents the steering shaft 16 from being rotated. In various embodiments the steering lock mechanism 29 may connect to the steering wheel 12 to prevent rotation of the steering wheel. In other embodiments the steering lock mechanism may be clamped or otherwise connected directly to the steering shaft 14 to prevent rotation of the steering shaft. Typically, the steering lock mechanism 29 is activated when the vehicle is turned off and the key removed.

Distinct from the anti-theft steering lock mechanism 29 is the friction clutch of this invention.

### Friction Clutch

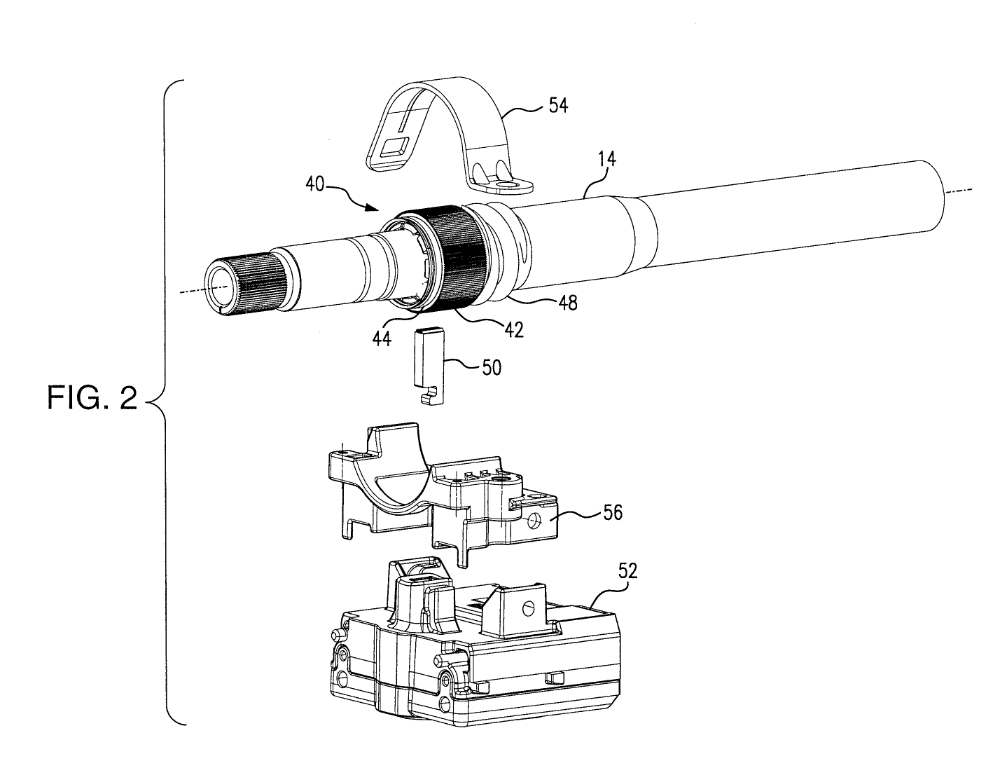

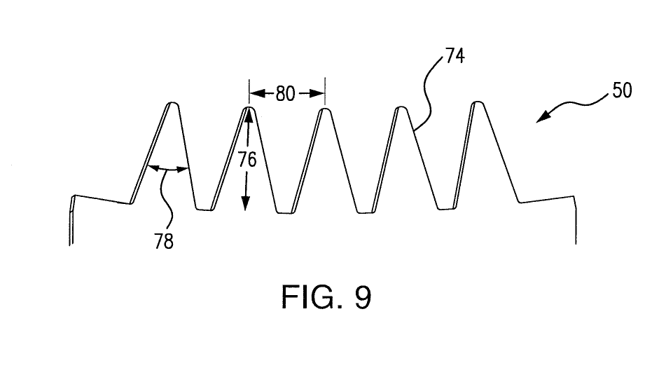

FIGS. 1-9 show the friction clutch 40 according to an embodiment of the present invention. The friction clutch 40 includes coupled members that rotate with the drive shaft 14 and an uncoupled member that does not necessarily rotate with the drive shaft 14. Surfaces of a coupled member abut a surface of the uncoupled member. The friction between such abutting surfaces provides the friction that must be overcome to overcome the friction clutch and allow rotation of the steering shaft 14 when the friction clutch 40 is engaged. Thus, the selected torque to overcome a locked friction clutch 40 must be sufficient to overcome the friction between the abutting surfaces.

In an example embodiment the friction clutch 40 includes a lock collar 42, a barrier 44, a tuning spring 48, a lock bolt 50, a lock bolt controller 52 and friction wedges 58, 59. The lock collar 42, barrier 44, tuning spring 48, and wedges 58, 59 circumferentially surround an axial length portion of the steering shaft 14. The lock bolt 50 is moved into and out of engagement with the lock collar 42 by the lock bolt controller 52. The lock bolt controller 52 is mounted on a housing 56 and held in position relative to the steering shaft 14 by a clamp 54.

### Barriers 44, 46:

The friction clutch 40 abuts against an enlarged diameter portion of the steering shaft 14. An edge of such enlarged diameter portion serves as a second barrier 46 for the friction clutch 40. The first barrier 44 may be embodied by a washer, such as a no-back washer. The first barrier 44 is able to be slid axially onto the steering shaft 14, while also having a tight fit to the steering shaft 14 so that when placed along the steering shaft 14, the barrier 14 rotates with the steering shaft 14 and does not slide axially along the steering shaft during a steering operation. The axial location of the barrier 44 defines an axial length between the second barrier 46 and the first barrier 44. In an alternative embodiment the second barrier need not be an enlarged diameter portion of the steering shaft 14, and instead may be another tight fitting washer of same or different construction as first barrier 44. In example embodiments the first barrier 44 (and barrier 46 when embodied as a discrete component distinct from the steering shaft 14) is formed from a steel material, or any of various alloy metals or other hard materials. The barriers 44, 46 are coupled members, which as used herein means that they rotate with the steering shaft 14.

### Lock Collar 42:

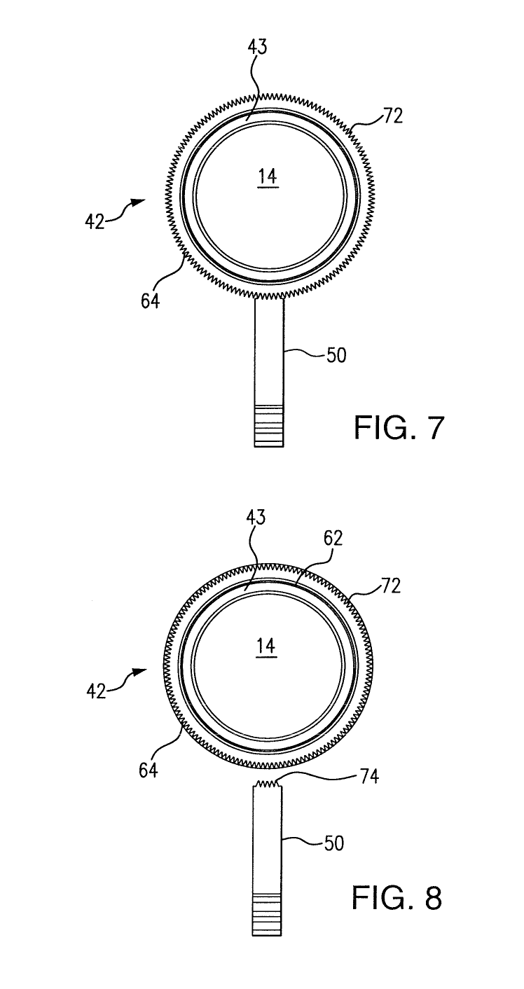

The lock collar 42 is an uncoupled member, which does not move with the steering shaft 14 during normal operation of the friction clutch 40. The lock collar 42 is a cylinder having inner surfaces 43, 45 and an outer circumferential surface 64. In example embodiments the lock collar 42 is formed from a steel material. In alternative embodiments the lock collar 42 is formed from any of various alloy metals or other hard materials. The lock collar 42 extends a longitudinal length from one end 66 to an opposite end 68. The lock collar 42 cylindrically surrounds a partial length of the steering shaft 14. In an exemplary embodiment the external circumferential surface 64 of the lock collar 42 includes a plurality of teeth 72 spanning the entire external circumference of the lock collar 42, (See FIGS. 7 and 8). The number of teeth 72 is prescribed according to a desired precision for controlling the clutched position of the steering shaft 14. For example, in an embodiment having 180 teeth, the steering shaft may be at any 2 degree interval of rotation when clutched, (i.e., 360 degrees circumference/180 teeth=2 degrees are length). The specific number of teeth 72 may vary according to the embodiment.

### Friction Wedge 58, 59:

Concentrically inward of the lock collar 42 are a pair of friction wedges 58, 59. Each wedge 58, 59 has a cylindrical central opening that extends axially through which the steering shaft 14 is received. Each wedge 58, 59 has a tight fit with the steering shaft so as to rotate with the steering shaft 14 during operation of the friction clutch 40. Accordingly, the friction wedges 58, 59 also a coupled members. In some embodiments each wedge 58, 59 has splines at the inner surface so as to provide a tight fit with the steering shaft 14 and prevent relative rotation between the steering shaft 14 and the corresponding wedge 58, 59.

An outward surface of each wedge away from the steering shaft 14 includes at least a section that is inclined so as to form a truncated conical surface 61, 63. For each wedge 58, 59 a direction of decreasing radius of the truncated conical surface is in a direction upon installation that is toward the other wedge 59, 58.

The lock collar 42 concentrically surrounds a portion of each wedge 58, 59 so that a portion of the truncated conical surfaces 61, 63 of each wedge abuts a corresponding inner surface 43, 45 of the lock collar. The friction forces between the lock collar inner surface 43 and the wedge 58 conical surface 61 and between the lock collar inner surface 45 and the wedge 59 conical surface 63 define the clutch forces for holding the steering shaft 14 against rotation.

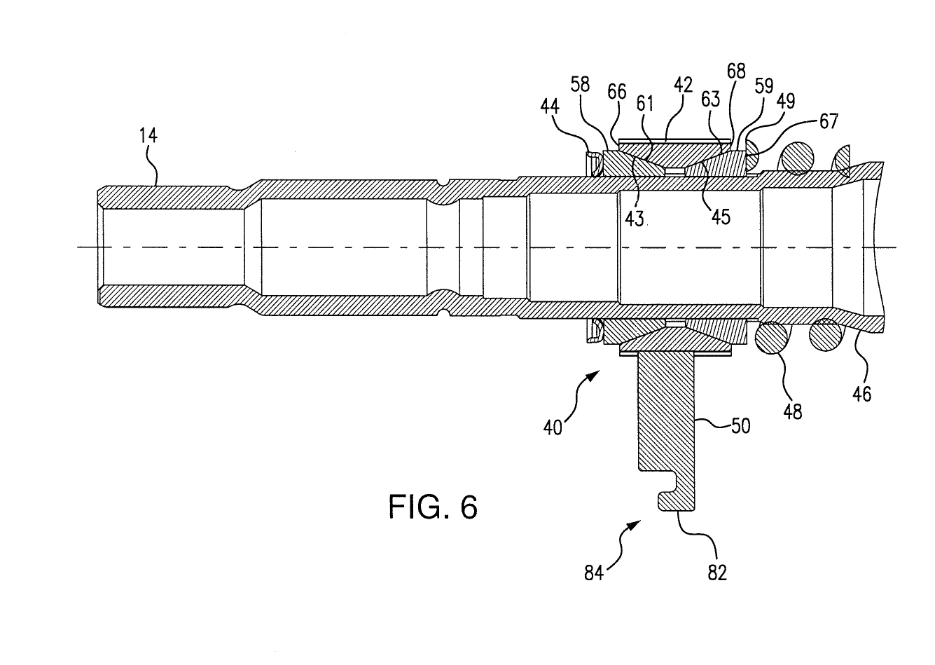

Each wedge has a smallest diameter end toward the other wedge. Each wedge is configured so that a larger diameter end directed away from the other wedge extends beyond a nearest end of the lock collar 42. (See FIG. 6). In other embodiments, the larger diameter end of a wedge may be flush with the nearest end of the lock collar upon installation. In still other embodiments, the larger diameter end of a wedge may be axially inward the nearest end of the lock collar upon installation, so as to be closer to the other wedge than such nearest end of the lock collar. The precise relative axial location of each wedge relative to the lock collar 42 is determined by the distance between the barriers 44, 46.

### Tuning Spring:

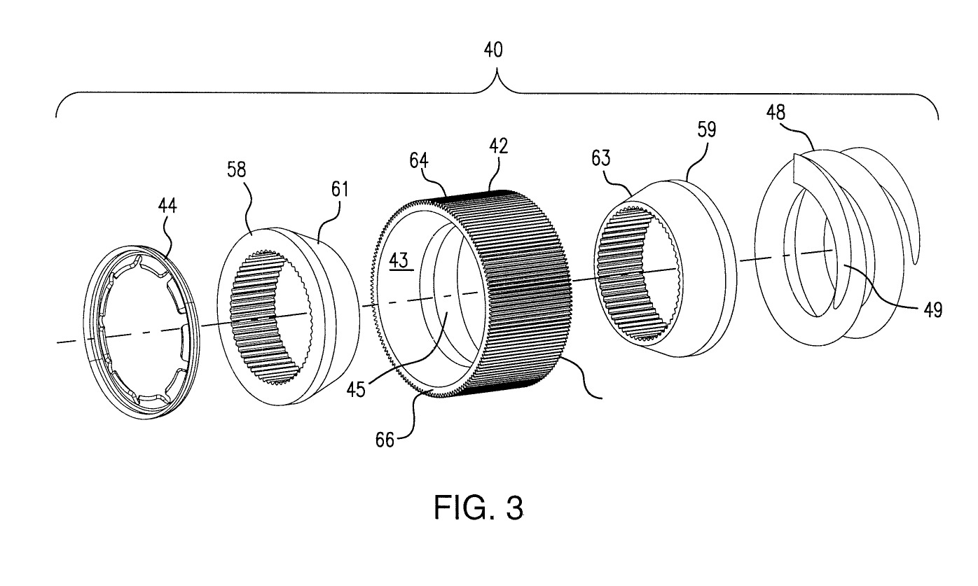

In one embodiment the tuning spring 48 is a helical coil compression spring providing an axial force for generating the rated torque of the friction clutch 40. In another embodiment the spring 48 is a belleville washer rather than a helically wound spring. In example embodiments the spring 46 is formed from tempered high-carbon steel, also known as spring steel. One axial end portion 49 of the spring 46 abuts an end of one of the wedges 59 (see FIGS. 3 and 6). At the other end of the spring 48, the spring 48 abuts the second the barrier 46. Friction between the barrier 46 and the spring 48 (and between the edge of the wedge 59 and the spring 48) causes the spring 48 to rotate with the barrier 46 and steering shaft 14 during operation of the friction clutch 40.

The axial position of the barrier 44 relative to barrier 46 determines the compressed length of the spring 48 during operation of the friction clutch 40. Accordingly, such axial position also defines the spring force with which one end 49 of the spring 48 acts on the abutting, contacted edge 67 of the wedge 59. Of significance is that the friction f1 between the contacted edge 67 of the wedge 59 and the spring 48 may be greater than the friction f2 between the wedge surfaces 61, 63 and the lock collar surfaces 43, 45. This assures that when there is sufficient torque to overcome the friction clutch 40, the rotational motion occurs between the lock collar 42 and the wedges 58, 59, rather than between the wedge 59 and the spring 48. When friction force f2 is overcome the steering shaft 14 will rotate even though the friction clutch is engaged. Friction force f1, accordingly, helps define the operational upper force boundary of the friction clutch 40 operating range.

Also significant is that the wedge surfaces 61, 63 are angled relative to the surface of the steering shaft 14. Consider a steering shaft section of constant diameter located concentrically inward of the wedge. Such steering shaft surface defines a reference cylinder (e.g., zero degrees) against which an incline angle of the truncated conical surfaces 61, 63 can be referred. The incline angle of each surface 61, 63 will alter a vector for determining how much of the force of the compression spring acts radially relative to the steering shaft 14 onto the surfaces 61, 63. For example, in an embodiment in which the select torque to overcome the friction clutch is to be 5 Nm, and in which the incline angles of both surfaces 61,63 are equal to each other at 20 degrees, the tuning spring would need to be compressed so as to provide a spring load of 367.7 N. In an embodiment where the incline angles 61, 63 are equal to each other at 15 degrees, then the spring load would need to be 278.3 N for the select value to overcome a locked friction clutch to be 5 Nm. Of significance is that less compression of the tuning spring 48 is needed for less of a wedge incline angle for a given select value needed to overcome a locked friction clutch. The specific inclined angles of surfaces 61, 63 may vary from the examples given. Also, in some embodiments the specific inclined angles of surfaces 61, 63 may differ from each other.

### Lock Bolt 50 and Controller 52:

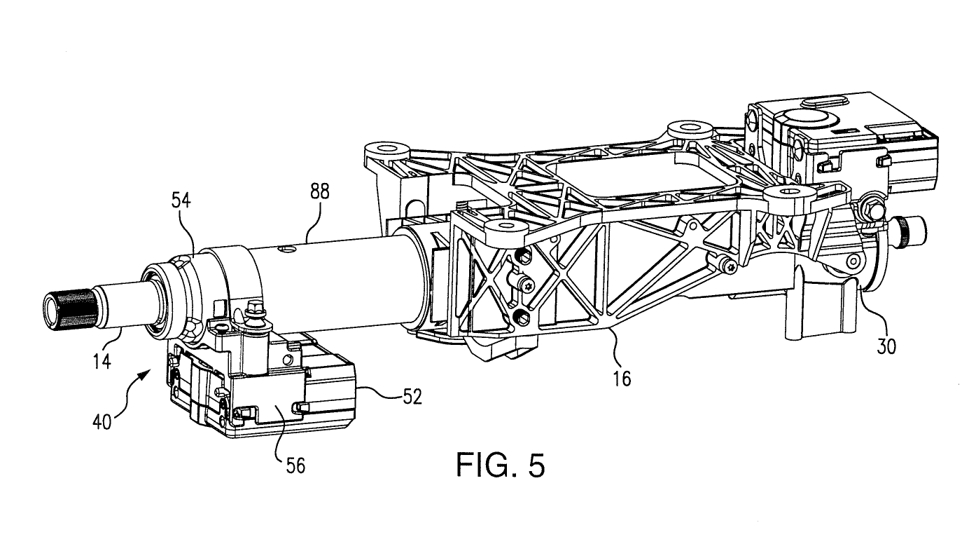

A lock bolt 50 serves to lock the lock collar 42 against rotation while the lock bolt 50 is in a locked position (See FIGS. 5-6). At one end the lock bolt 50 includes teeth 74 configured to engage teeth 72 at the exterior surface 64 of the lock collar 42 while the lock bolt 50 is in the locked position. Although the height, angle and spacing of the teeth 74 may vary, in one embodiment each tooth 74 has a height 76 of 1.02 mm, a tooth angle 78 of 27.5 degrees, and a tooth spacing 80 (measured at distal peak of tooth) of 0.8 mm. The teeth 72 of the lock collar 42 have the same dimensions as those of the lock bolt 50. In other embodiments the dimensions of teeth 72 may vary to be the same or different than the dimensions of the teeth 74.

At an opposite end 82 the lock bolt 50 may include a catch structure 84 or other hooking structure for being held by an actuator of the controller 52. The controller actuator changes positions to move the lock bolt 50 into or out of engagement with the lock collar 42. In some embodiments the controller 52 has a default condition placing the lock bolt 50 into engagement with the lock collar. For example, upon a loss of power the lock bolt 50 would automatically move into the locked position. Under normal driving conditions, in each of manual steering mode and automatic steering mode, the controller 52 receives a signal to move the lock bolt 50 into the unlocked position. In some embodiments, the driver can flip a switch or provide another form of input to select the position of the lock bolt 50 as being either in the locked position or the unlocked position. In some embodiments a manual release is provided by which the driver, even during a loss of power, can switch the position of the lock bolt 50 into the unlocked position. For example, the actuator of the controller 52 may be mechanically moved by such release to switch the position of the lock bolt 50 into the unlocked position.

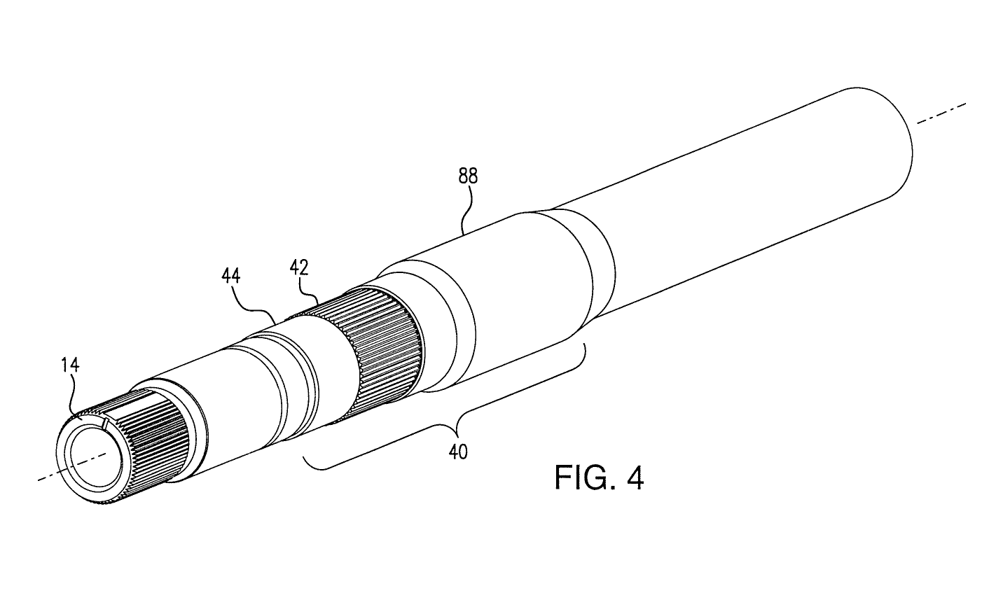

In some embodiments a jacket tube 88 may encase the lock collar 42, barriers 44, 46, spring 48, and bearing 58. (See FIGS. 4-5). The lock bolt 50 and controller 52 may be located outside such jacket tube 88. An opening in the jacket tube 88 is provided to allow the lock bolt 50 to contact the lock collar 42. The clamp 54 and mount 56 also may be outside the jacket tube 88. In a preferred embodiment the jacket tube has a diameter greater than the diameter of the lock collar 42, so that the jacket tube provides no rotational restriction on the lock collar 42.

### Actuation During Self-Driving Modes:

In a vehicle having either a self-driving mode or hands-free driving mode, the controller 36 may generate command for a motor 34 to turn the steering shaft 14 so as to navigate the vehicle. During such modes of operation, the driver need not hold the steering wheel. The controller 36 determines whether to vary the rotational position of the steering shaft, such as to turn the vehicle or to correct alignment of the vehicle deviating from an intended heading. During some time periods of self-driving or hands-free driving, the steering shaft rotational position may not need to be adjusted nor otherwise rotated. During such time periods the controller 36 may signal the locking mechanism controller 52 to move the locking bolt 50 into engagement with the lock collar 42 so as to lock the friction clutch 40. While locked the steering shaft 14 is maintained at is then current rotational position. When the controller 36 determines that the steering shaft 14 rotational position needs to be adjusted or otherwise altered, the controller 36 may send a signal to the locking mechanism controller 52 to have the locking bolt 50 disengage from the lock collar 42, thereby unlocking the friction clutch 40. The controller 52 actuates the locking bolt 50 to move into the locked or unlocked position as per the desired locked or unlocked state of the friction clutch 40. Once the steering adjustment is made, then the controller signals the controller 52 to re-lock the friction clutch 40. Such locking and unlocking may occur frequently during the self-driving or hands-free steering mode so that the friction clutch serves to hold the steering wheel as would a driver, (i.e., holding the wheel steady at times; unlocking for allowing minor adjustments; unlocking for allowing vehicle turning).

### Actuation as a Failsafe:

If a failure occurs during a self-driving operation or hands-free steering operation, such as a loss of power, in some embodiments the friction clutch will default to a locked position. For example, if the vehicle is rounding a curve during the failure, the friction clutch will lock in the current rotational angle and the vehicle will continue turning along a curve. As the driver realizes that power is lost, such as by the vehicle continuing to turn while the road straightens out, the driver may grab the steering wheel 12 and apply at least the select torque so s to overcome the friction clutch and turn the steering shaft to a desired rotational position.

In some embodiments, such action will cause automatic disengagement of the friction clutch 40. In other embodiments, the friction clutch will remain locked and thus hold the steering shaft 14 at the new rotational position that resulted from the manual intervention by the driver. Thus, if the driver lets go the friction clutch holds the steering shaft 14 at its new current rotational position.

In some embodiments, a manual button is available on the steering column accessible to the driver to disengage, or engage, the friction clutch 40.

### Other Alternative Embodiments

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. For example, although the barrier 44, tuning spring 48, and wedges 58, 59 may contact the steering shaft 14 directly, in some embodiment such components instead may contact a sleeve 90 of the steering shaft 14. For example, the sleeve may have a tight fit to the steering shaft so as to rotate with the steering shaft 14. The barrier 44, the spring 48, and the wedges 58, 59 rotate with the sleeve 90 and steering shaft 14.

The invention is intended to extend to all functionally equivalent structures, methods and uses, such as are within the scope of the appended claims. Those skilled in the art, having the benefit of the teachings of this specification, may affect numerous modifications thereto and changes may be made in form and details without departing from the scope and spirit of the invention.

1. A friction clutch apparatus for clutching a steering shaft, comprising:
a first clutching surface and a second clutching surface configured to be pressed against each other with a clutching force, wherein the first clutching surface is configured to be axially and rotationally fixed relative to the steering shaft, and wherein the second clutching surface is configured to allow rotation of the steering shaft within an axial through opening of the second clutching surface; and
a locking component having a locked position in which the locking component fixes a rotational position of the second clutching surface; and
wherein the first and second clutching surface and the locking component are configured so that while the locking component is in the locked position the clutching force resists rotation of the steering shaft; and
wherein the clutching force can be overridden by application of an external torque at the steering wheel that corresponds to an overriding force acting on the steering shaft exceeding the clutching force.

2. The friction clutch apparatus of claim 1, wherein the clutching force continues to resist rotation of the steering shaft upon removal of said external torque.

3. The friction clutch apparatus of claim 1, further comprising:
a collar configured to be installed along the steering shaft and having said second clutching surface that allows rotation of the steering shaft within said axial through opening while the friction clutch is active within a frictional force operational range; and
a first barrier axially and rotationally fixed relative to the steering shaft; and
a spring configured to be installed along the steering shaft between the first barrier and a body having said first clutching surface; and
wherein the locking component is movable relative to the collar into and out of the locked position in which the locking component locks the rotational position of the collar; and
wherein a compressed length of the spring determines a force by which the spring acts upon one axial end of the body, said force determining the frictional force operational range of the friction clutch apparatus.

4. The friction clutch apparatus of claim 3, wherein said body comprises a wedge axially positioned along the steering shaft, said wedge having an axial through opening into which the steering shaft is received, said wedge having an outward surface comprising said first clutching surface;
wherein the outward surface of the wedge abuts a corresponding inner surface of the collar serving as the second clutching surface.

5. The friction clutch apparatus of claim 3, further comprising a first wedge and a second wedge axially positioned along the steering shaft, each one of said first wedge and second wedge having an axial through opening into which the steering shaft is received, each one of the first wedge and second wedge having an outward surface comprising said first clutching surface, said body being said first wedge;
wherein the outward surface of the first wedge serves as a first portion of the first clutching surface and abuts a corresponding inner surface of the collar serving as a first portion of the second clutching surface; and
wherein the outward surface of the second wedge serves as a second portion of the first clutching surface and abuts a corresponding inner surface of the collar serving as a second portion of the second clutching surface.

6. The friction clutch apparatus of claim 5, further comprising a second barrier axially and rotationally fixed relative to the steering shaft and axially located at an axial end of the second wedge away from the first wedge; and
wherein the second barrier is slidable onto the steering shaft while also forming a tight fit with the steering shaft to maintain a fixed position along the steering shaft during operation of the friction clutch; and
wherein the fixed position determines the compressed length of the spring.

7. The friction clutch apparatus of claim 3, further comprising a controller that controls whether the locking component is positioned in or out of the locked position.

8. The friction clutch apparatus of claim 3, wherein the collar has a toothed outer surface, and wherein the locking component has a toothed surface which engages said toothed outer surface when the locking component is in the locked position.

9. The friction clutch apparatus of claim 3, configured as a failsafe apparatus for clutching the steering shaft to simulate a driver holding a position of a steering wheel during a failure of automated steering control in the vehicle, the vehicle having a self-driving mode and a manual driving mode; and
wherein the first and second clutching surface and the locking component are configured while the locking component is in the locked position the clutching force simulates a driver holding a steering wheel at a current rotational position of the steering shaft.

10. The friction clutch apparatus of claim 1, configured as a failsafe apparatus, wherein the first and second clutching surface and the locking component are configured while the locking component is in the locked position so that the clutching force simulates a driver holding a steering wheel at a current rotational position of the steering shaft during a failure of automated steering control in the vehicle, the vehicle having a self-driving mode and a manual driving mode.

11. A friction clutch apparatus for clutching a steering shaft, comprising:
a first barrier fixed relative to the steering shaft;
a second barrier fixed relative to the steering shaft;
a collar and a friction wedge each configured to be installed along the steering shaft between the first barrier and the second barrier, the collar having an axial through opening with a portion of the friction wedge being within the axial through opening;
a tuning spring installed along the steering shaft between the friction wedge and one of the first and second barriers; and
a locking component having a locked position and an unlocked position; and
wherein the friction wedge includes a first clutching surface as an outer surface concentrically inward of the collar, and has a friction wedge axial through opening configured to receive the steering shaft;
wherein the collar includes a second clutching surface which is an inner surface about the collar's axial through opening, the first clutching surface and the second clutching surface configured to be pressed against each other with a clutching force determined at least in part by the tuning spring;
wherein the first barrier is positioned relative to the second barrier to define a compressed length of the tuning spring that determines forces by which the tuning spring acts upon the friction wedge to achieve the clutching force;
wherein in the locked position the locking component fixes a rotational position of the second clutching surface;
wherein the first and second clutching surface and the locking component are configured so that while the locking component is in the locked position the clutching force resists rotation of the steering shaft; and
wherein the clutching force can be overridden by application of an external torque at a steering wheel coupled to the steering shaft, the external torque corresponding to an overriding force acting on the steering shaft exceeding the clutching force.

12. The friction clutch apparatus of claim 11, wherein the second barrier is slidable onto the steering shaft while also forming a tight fit with the steering shaft to maintain the fixed position along the steering shaft during operation of the friction clutch.

13. The friction clutch apparatus of claim 11, wherein the first barrier is an area of increasing diameter portion of the steering shaft.

14. The friction clutch apparatus of claim 11, further comprising a controller that controls whether the locking component is positioned in or out of the locked position.

15. The friction clutch apparatus of claim 11, wherein the collar has a toothed outer surface, and wherein the locking component has a toothed surface which engages said toothed outer surface when the locking component is in the locked position.

16. The friction clutch apparatus of claim 11, configured as a failsafe apparatus for clutching the steering shaft to simulate a driver holding a position of a steering wheel during a failure of automated steering control in the vehicle, the vehicle having a self-driving mode and a manual driving mode; and
wherein the first and second clutching surface and the locking component are configured while the locking component is in the locked position the clutching force simulates a driver holding a steering wheel at a current rotational position of the steering shaft.

17. The friction clutch apparatus of claim 11, configured as a failsafe apparatus, wherein the first and second clutching surface and the locking component are configured while the locking component is in the locked position so that the clutching force simulates a driver holding a steering wheel at a current rotational position of the steering shaft during a failure of automated steering control in the vehicle, the vehicle having a self-driving mode and a manual driving mode
